(19) United States
(12) Patent Application Publication
(10) Pub. No.: US 2020/0221381 A1
(43) Pub. Date: Jul. 9, 2020

(54) TARGET WAKE TIME (TWT) PROTOCOL FOR WI-FI VOICE CALLS

(71) Applicant: QUALCOMM Incorporated, San Diego, CA (US)

(72) Inventors: Sandip HOMCHAUDHURI, San Jose, CA (US); Yongchun XIAO, San Jose, CA (US); Vasudev Sujir NAYAK, San Diego, CA (US); Daniel Jared SINDER, San Diego, CA (US); Vincent Knowles JONES, IV, Redwood City, CA (US); Vikram SINGH, San Diego, CA (US); Chinmay DHODAPKAR, San Diego, CA (US)

(21) Appl. No.: 16/711,993

(22) Filed: Dec. 12, 2019

Related U.S. Application Data
(60) Provisional application No. 62/817,025, filed on Mar. 12, 2019.
(60) Provisional application No. 62/789,167, filed on Jan. 7, 2019.

(51) Int. Cl. H04W 52/02; H04W 76/50; H04W 36/12; H04L 12/853; H04M 7/00; H04W 80/02; H04W 4/90

(52) U.S. Cl. CPC H04W 52/0216; H04W 52/0206; H04W 52/0235; H04W 52/0274; H04W 76/50; H04M 2242/04; H04L 47/2416; H04M 7/0084; H04W 80/02; H04W 4/90; H04W 36/12

(57) ABSTRACT

Certain aspects of the present disclosure provide an apparatus for wireless communication. The apparatus generally includes an interface configured to obtain at least one voice packet from an access point (AP), wherein the at least one voice packet is obtained during one or more service periods (SPs) of a target wake time (TWT) protocol, and a processing system configured to process the at least one voice packet obtained during the one or more SPs.

### CROSS-REFERENCE TO RELATED APPLICATION

This application claims benefit of and priority to U.S. Provisional Patent Application Ser. No. 62/789,167, filed Jan. 7, 2019, and U.S. Provisional Patent Application Ser. No. 62/817,025, filed Mar. 12, 2019, herein incorporated by reference in their entirety as if fully set forth below and for all applicable purposes.

### FIELD

Certain aspects of the present disclosure generally relate to wireless communications and, more particularly, to voice over internet protocol (VOIP).

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that communicates with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink (or forward link) may refer to the communication link from the AP to the STA, and the uplink (or reverse link) may refer to the communication link from the STA to the AP.

### SUMMARY

Certain aspects of the present disclosure provide an apparatus for wireless communications. The apparatus generally includes an interface configured to obtain at least one voice packet from an access point (AP), wherein the at least one voice packet is obtained during one or more service periods (SPs) of a target wake time (TWT) protocol, and a processing system configured to process the at least one voice packet obtained during the one or more SPs.

Certain aspects of the present disclosure provide a method for wireless communications by an apparatus. The method generally includes obtaining, via an interface, at least one voice packet from an access point (AP), wherein the at least one voice packet is obtained during one or more service periods (SPs) of a target wake time (TWT) protocol and processing the at least one voice packet obtained during the one or more SPs.

Certain aspects of the present disclosure provide an apparatus for wireless communications. The apparatus generally includes means for obtaining, via an interface, at least one voice packet from an access point (AP), wherein the at least one voice packet is obtained during one or more service periods (SPs) of a target wake time (TWT) protocol and means for processing the at least one voice packet obtained during the one or more SPs.

Certain aspects of the present disclosure provide a computer-readable medium for wireless communications. The computer-readable medium generally includes codes executable to obtain at least one voice packet from an access point (AP), wherein the at least one voice packet is obtained during one or more service periods (SPs) of a target wake time (TWT) protocol and process the at least one voice packet obtained during the one or more SPs.

Certain aspects of the present disclosure provide a station that generally includes at least one antenna, an interface configured to obtain, via the at least one antenna, at least one voice packet from an access point (AP), wherein the at least one voice packet is obtained during one or more service periods (SPs) of a target wake time (TWT) protocol and a processing system configured to process the at least one voice packet obtained during the one or more SPs.

Certain aspects of the present disclosure provide an apparatus for wireless communication. The apparatus generally includes a processing system configured to generate at least one voice packet, and a first interface configured to output the at least one voice packet for transmission to a station, wherein the at least one voice packet is output for transmission during one or more SPs of a TWT protocol.

Certain aspects of the present disclosure provide a method for wireless communication. The method generally includes generating at least one voice packet, and outputting the at least one voice packet for transmission to a station, wherein the at least one voice packet is output for transmission during one or more SPs of a TWT protocol.

Certain aspects of the present disclosure provide an apparatus for wireless communication. The apparatus generally includes means for generating at least one voice packet, and means for outputting the at least one voice packet for transmission to a station, wherein the at least one voice packet is output for transmission during one or more SPs of a TWT protocol.

Certain aspects of the present disclosure provide a computer-readable medium for wireless communications. The computer-readable medium generally includes codes executable to generate at least one voice packet and output the at least one voice packet for transmission to a station, wherein the at least one voice packet is output for transmission during one or more service periods (SPs) of a target wake time (TWT) protocol.

Certain aspects of the present disclosure provide an AP having at least one antenna, a processing system configured to generate at least one voice packet, and a first interface configured to output the at least one voice packet for transmission to a station via the at least one antenna, wherein the at least one voice packet is output for transmission during one or more SPs of a TWT protocol.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example stations, in accordance with certain aspects of the present disclosure.

FIG. 3 illustrates an example wireless device, in accordance with certain aspects of the present disclosure.

FIG. 4 illustrates a target wake time (TWT) protocol, in accordance with certain aspects of the present disclosure.

FIG. 5 is a flow diagram illustrating example operations for wireless communication, in accordance with certain aspects of the present disclosure.

FIG. 6 is a flow diagram illustrating example operations for wireless communication, in accordance with certain aspects of the present disclosure.

FIG. 7 is a graph illustrating different TWT parameters that may be adjusted, in accordance with certain aspects of the present disclosure.

FIG. 8 is a table illustrating TWT parameter settings based on congestion and background traffic, in accordance with certain aspects of the present disclosure.

FIG. 9 illustrates a voice packet flow over a real-time transport protocol (RTP) link and Wi-Fi link, in accordance with certain aspects of the present disclosure.

FIG. 10 is a table illustrating link parameter setting based on codec states, in accordance with certain aspects of the present disclosure.

FIG. 11 illustrates an exemplary control field subfield for operating mode control.

FIG. 12 illustrates example operations for improving power efficiency, in accordance with certain aspects of the present disclosure.

FIG. 13 illustrates example operations for setting WiFi communication parameters based on whether a corresponding call has been placed on hold, in accordance with certain aspects of the present disclosure.

FIG. 14 illustrates example operations for improving link quality prior to transition of a voice call to cellular, in accordance with certain aspects of the present disclosure.

FIG. 15 illustrates example operation for adjusting TWT and/or link parameters based on call priority, in accordance with certain aspects of the present disclosure.

FIG. 16 illustrates example operation for configuring a voice call based on backhaul link estimation, in accordance with certain aspects of the present disclosure.

FIG. 17 illustrates example operations for facilitating an emergency call back mode (ECBM), in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals, including as those according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other signals that are used to communicate within a wireless, cellular or internet of things (IOT) network, such as a system utilizing 3G, 4G or 5G, or further implementations thereof, technology.

The techniques described herein may be used for various broadband wireless communication systems, including communication systems that are based on a single carrier transmission. Aspects may be, for example, carried out on systems employing Ultra-Wide Band (UWB) signals including millimeter-wave signals. However, this disclosure is not intended to be limited to such systems, as other coded signals may similarly benefit.

The techniques may be incorporated into (such as implemented within or performed by) a variety of wired or wireless apparatuses (such as nodes). In some implementations, a node includes a wireless node. Such a wireless node may provide, for example, connectivity to or for a network (such as a wide area network (WAN) such as the Internet or a cellular network) via a wired or wireless communication link. In some implementations, a wireless node may include an access point or a station.

Certain aspects of the present disclosure are generally directed to techniques for improving call quality and power efficiency by facilitating communication between codec and WiFi systems. For example, timing of periods during which the WiFi system may be in a low-power state of operation may be shared with the codec system, allowing the codec system to also reduce power consumption during those periods in sync with the WiFi system, as described in more detail herein. The codec may also convey a type of voice call that is currently active or to be received to the WiFi system, allowing the WiFi system to adjust WiFi session parameters to either improve efficiency (e.g., when a call is on hold) or improve call quality (e.g., for a high priority call).

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth.

An SDMA system may utilize sufficiently different directions to simultaneously transmit data belonging to multiple stations. A TDMA system may allow multiple stations to share the same frequency channel by dividing the transmission signal into different time slots, each time slot being assigned to different stations. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller, an evolved Node B, a Base Station Controller, a Base Transceiver Station, a Base Station, a Transceiver Function, a Radio Router, a Radio Transceiver, a Basic Service Set (“BSS”), an Extended Service Set, a Radio Base Station, or some other terminology.

An access terminal (“AT”) may comprise, be implemented as, or known as a subscriber station, a subscriber unit, a mobile station, a remote station, a remote terminal, a station, a user agent, a user device, user equipment, a user station, or some other terminology. In some implementations, an access terminal may comprise a cellular telephone, a cordless telephone, a Session Initiation Protocol phone, a wireless local loop station, a personal digital assistant, a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

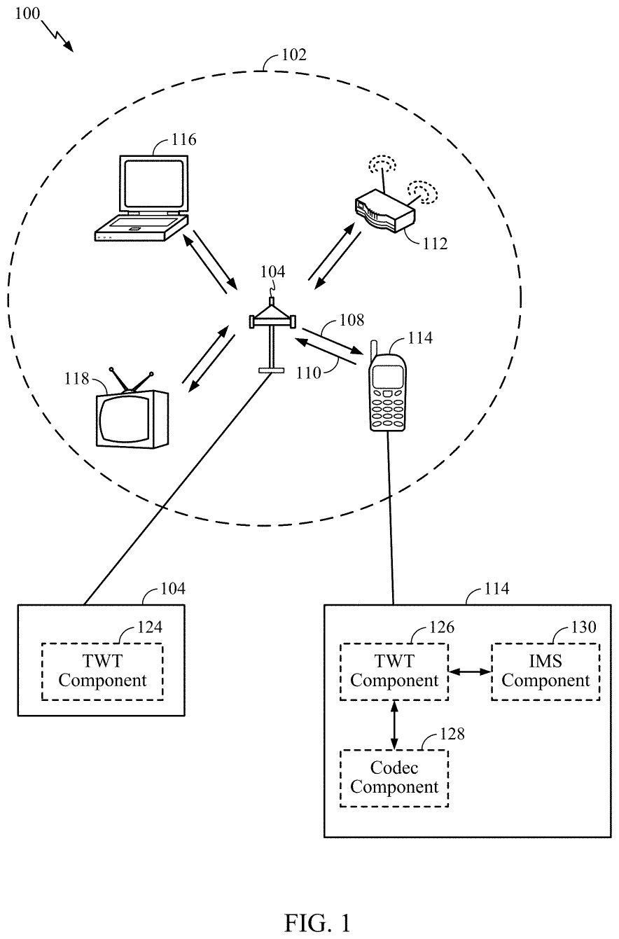

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM or orthogonal frequency-division multiple access (OFDMA) techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system. In an aspect, the wireless communication system 100 may support MIMO transmissions, including single-user MIMO and multi-user MIMO. The wireless communication system 100 may also support multi-user OFDMA, etc.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104.

In an aspect, the AP 104 may include one or more components for performing various functions. For example, the AP 104 may include a target wake time (TWT) component 124 to perform procedures related to TWT operations/scheduling. A TWT procedure is used to schedule service periods (SPs) for STAs during which the STA can wake up (e.g., power up transceiver circuitry) for signal communication, allowing the STAs to doze (e.g., power down transceiver circuitry) at other times to save power.

In Wi-Fi networks, an AP often serves multiple STAs within a BSS as illustrated in FIG. 1. When STAs (e.g., STAs 112, 114, 116, 118) have data to transmit or receive, STAs exchange UL/DL frames with the AP (e.g., in a multi-user context). The UL/DL frames refer to UL only, DL only, or both. To perform data transmission or reception, STAs may need to receive a trigger frame from the AP to enable the UL/DL exchange. A trigger frame may contain a set of resource allocations for the UL/DL exchange. To receive the trigger frame, a STA may need to be in an awake mode/state for unknown periods of time to wait for a trigger frame. Potentially long and frequent periods spent waiting for a trigger frame increases power consumption of the STA. As such, a need exists to reduce power consumption by lowering the airtime needed for UL/DL frame exchanges. One solution is to implement a TWT scheduling protocol in which devices (e.g., STAs or APs) may be scheduled to sleep and wake up at specific times to perform UL/DL exchanges and trigger frames may be scheduled for transmission at predetermined or negotiated times. When a STA or an AP is not scheduled to be awake to receive trigger frames, for example, the STA or the AP can be in sleep mode (or power save mode) to conserve power. The TWT scheduling protocol is beneficial to any scheduling mechanism that may be negotiated between devices or dictated by one device to schedule intervals of time during which to exchange information between two or more devices.

In an aspect, TWT component referred to herein may be a scheduling component. The TWT component 124 may be configured to determine a TWT schedule. In some cases, the TWT component 124 may be configured to determine a TWT schedule and to broadcast a message that may include the determined TWT schedule to one or more wireless devices. The message may include a broadcast indicator that indicates the TWT schedule is a broadcast TWT schedule.

In another aspect, the STA 114 may include one or more components for performing various functions. For example, the STA 114 may include a TWT component 126 to perform procedures related to TWT operation/scheduling. In some cases, the TWT component 126 may be configured to receive a message that includes a TWT schedule. In another example, the TWT component 126 may be configured to determine whether to switch to an active mode, a power save mode, or a TWT power save mode based on the TWT protocol. During the TWT power save mode (PM), the STA 114 may enter an awake state during TWT SPs and may enter a doze state outside of the TWT SPs, as described in more detail herein.

In certain aspects, the STA 114 may include a codec component 128, which is circuitry or software for encoding or decoding a digital data stream or signal, such as audio signals which may be communicated via WiFi. As described in more detail herein, the TWT component 126 and the codec component 128 may synchronize time periods during which associated hardware components may enter a low-power mode of operation (e.g., a doze state outside of TWT SPs). In certain aspects, the STA 114 may also include an internet protocol (IP) multimedia subsystem (IMS) component 130, which may be circuitry or software for delivering multimedia services, such as voice packet via VOIP. For example, the IMS component 130 may monitor call quality metrics to determine whether to transition a voice call from WiFi to cellular, as described in more detail herein.

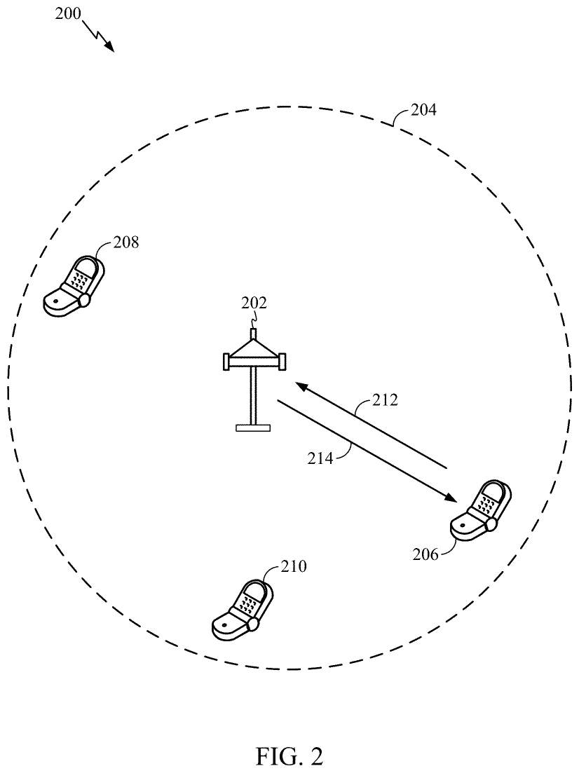

FIG. 2 includes an exemplary diagram 200 of a wireless network implementing TWT scheduling. The diagram illustrates an AP 202 broadcasting or transmitting within a BSS 204. STAs 206, 208, 210 are within the BSS 204 and are served by the AP 202. The STAs 206, 208, 210 and the AP 202 may perform TWT scheduling.

In one configuration, the STA 206 and the AP 202 may negotiate the TWT scheduling. In this configuration, the STA 206 may act as the TWT requester and initiate TWT setup with the AP 202 (although STA 206 and the AP 202 may also reverse roles). During TWT setup, the STA 206 may transmit a first message 212 (e.g., an action frame, association frame, or another frame) to the AP 202, which may act as the TWT responder. The first message 212 may include a TWT element. The first message 212 may include a first element ID identifying the TWT element. The first message 212 may include a first TWT request field indicating that the TWT element is a TWT request.

In certain aspects, the STA 206 may set a first TWT setup command to “Request TWT” to enable to AP 202 to set a TWT for the STA 206. In another aspect, the STA 206 may set the first TWT setup command to “Suggest TWT” to indicate a suggested/requested TWT to the AP 202. In addition, the STA 206 may set other parameters of the TWT request to indicate other parameters for the request. The STA 206 may also indicate a channel and/or subchannels in the TWT channel field for use during the scheduled TWT. In an aspect, the STA 206 may further indicate OFDMA subchannels in an OFDMA subchannel bitmap field within the first message 212.

After receiving the first message 212 from the STA 206, the AP 202 may determine whether to schedule one or more target wake times based on the first message 212. The AP 202 may determine whether to schedule TWTs for the STA 206 based on the number of STAs and/or the amount of data traffic within the BSS 204. For example, if the AP 202 detects a large number of STAs (e.g., 4) in the BSS 204, the AP 202 may improve channel contention by spreading out the wake up times of STAs if the STAs are operating in single user (SU) mode or concentrate the STAs wake up times if they are operating in multi-user (MU) mode. By contrast, if the AP 202 detects a small number of STAs (e.g., 1 or 2), the AP 202 may schedule the target wake times closely so that resources are not wasted and data rates may be high.

If the AP 202 determines that the medium is busy, the AP 202 may spread out the wake up times of the STAs to reduce traffic. If the medium is not busy, the AP 202 may schedule the target wake times closely. In an aspect, if the AP 202 determines that the medium is not busy and the first message 212 includes a suggested TWT, the AP 202 may determine to accept the TWT requested in the first message 212. In another aspect, if the medium is busy, the AP 202 may determine to provide a scheduled TWT that is different from the suggested/requested TWT of the STA 206. In yet another aspect, the AP 202 may determine not to schedule a TWT for the STA 206. The AP 202 may transmit a second message 214 to the STA 206. The second message 214 may be a TWT response to the TWT request (e.g., the first message 212) transmitted by the STA 206 (solicit TWT setup).

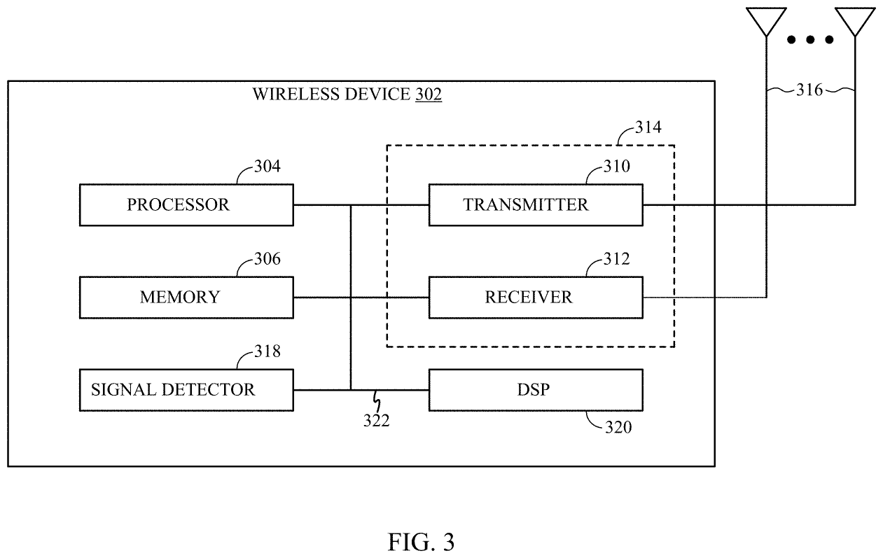

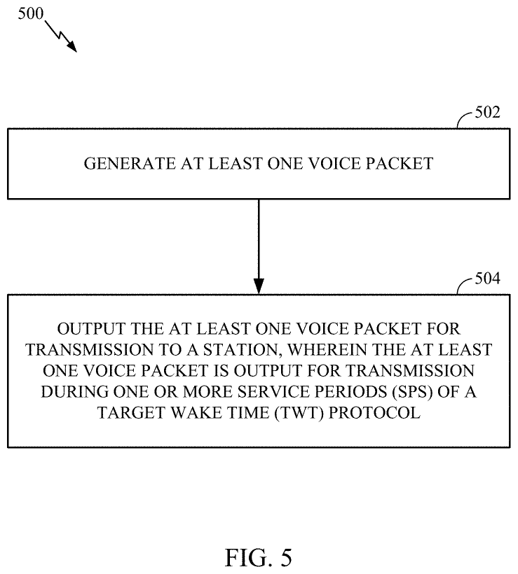

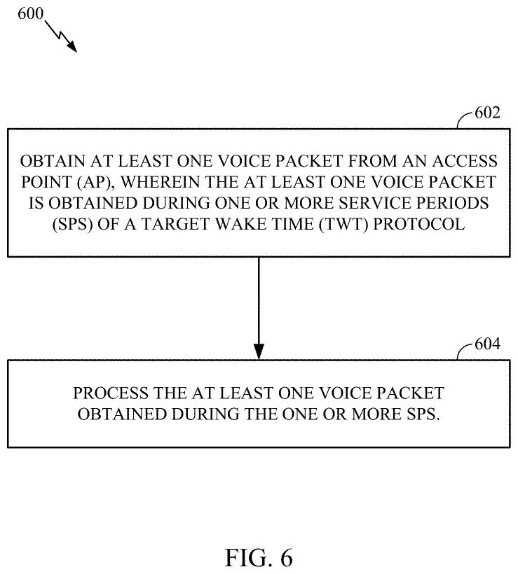

FIG. 3 illustrates various components that may be utilized in a wireless device 302. The wireless device 302 is an example of a device that may be configured to implement the various methods described herein. For example, the wireless device may implement operations set forth in FIGS. 5 and 6. The wireless device 302 may be an access point 104 or a station 114.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Techniques for Wi-Fi Calling (WFC) with a Target Wake Time (TWT) Protocol

As described herein, a target wake time (TWT) protocol allows devices to determine when and how frequently to wake up to send or receive data. Thus, TWT protocol increases device sleep time to conserve battery life. In addition to saving power, TWT allows access points (APs) negotiate and define specific times to access the medium.

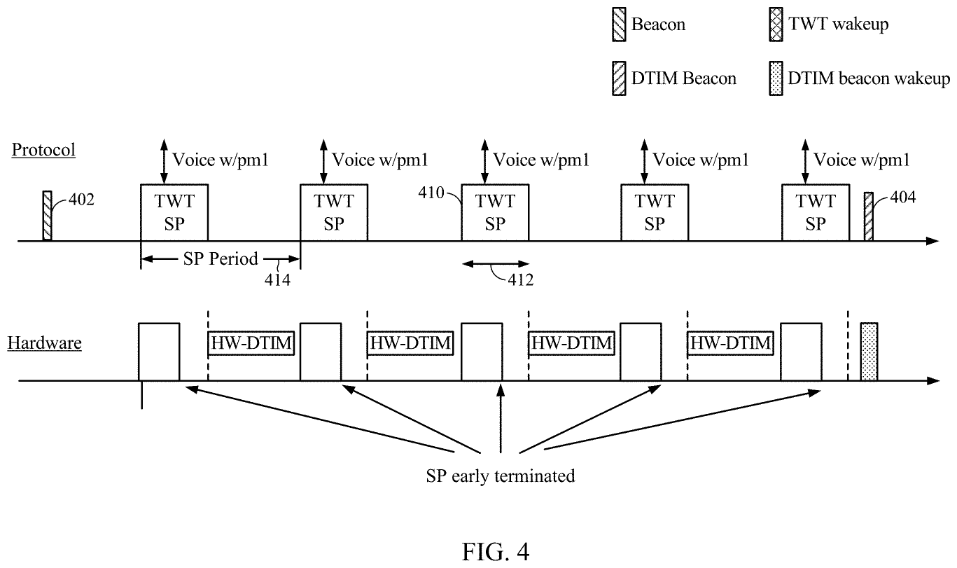

FIG. 4 illustrates a TWT protocol, in accordance with certain aspects of the present disclosure. As illustrated, periodic TWT service periods (SPs) are configured for the TWT protocol, during which a station (STA) wakes up to receive or transmit signaling. Outside the TWT SPs, the STA may be dozing its hardware circuits to save power. There may be no explicit control frames over the air exchanged to indicate these slot boundaries as seen in previous generations of Wi-Fi. The IEEE 802.11AX specification provides for an implicit mode of operation that allows devices to a priori configure the SPs, their periodicity, and placement in the time axis. The TWT protocol may begin with a beacon 402 and end with a delivery traffic indication message (DTIM) beacon 404, as illustrated. In some cases, the SP may early terminate, allowing the STA hardware (e.g., receiver and transmitter circuitry) to power down to conserve battery, as illustrated.

Due to the configuration of SPs for signaling, protocols having a deterministic pattern are best suited for communication via a TWT protocol. That said, traffic during a voice call (Wi-Fi Calling (WFC)) has a deterministic pattern governed by codec packetization and silence suppression methods. For example, voice packets may be coded at a 20 ms (or a 40 ms) periodicity at the source and sent over real-time transport protocol (RTP) encoding. Certain aspects of the present disclosure are directed to WFC using a TWT protocol to achieve a balance of low power and voice call quality by mapping the periodic traffic into the aligned TWT slots, as illustrated in FIG. 4.

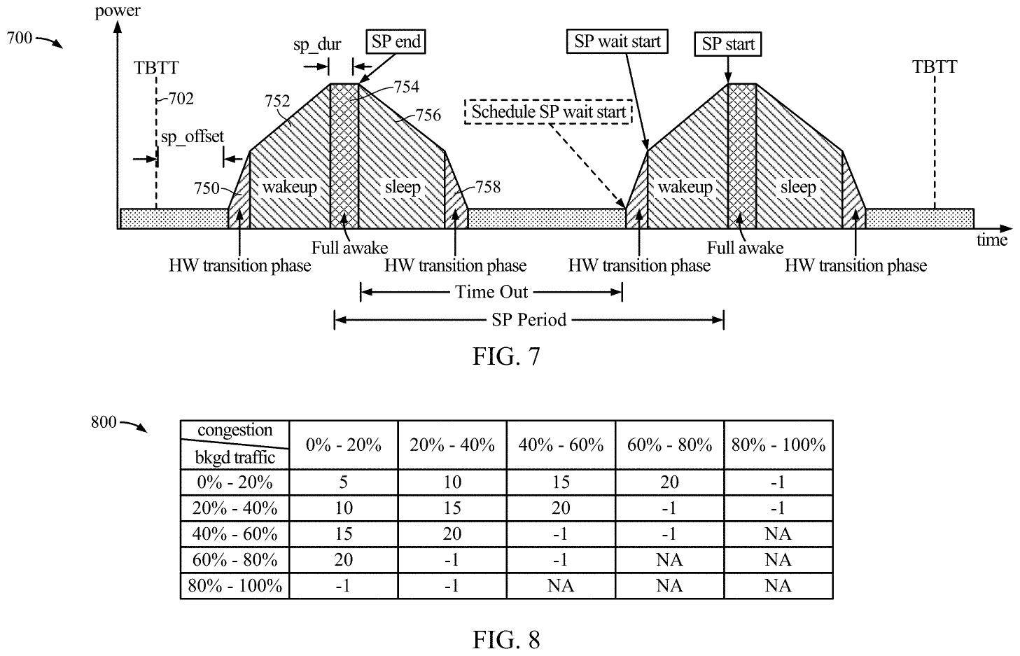

Several TWT session parameters may be configurable for the TWT protocol. For example, the TWT slots may be configured to have a specific size. For instance, the TWT slot 410 may be configured with a duration (e.g., represented by line 412) of 5 ms. Other TWT session parameters may include the TWT period (e.g., SP period) (e.g., represented by line 414) and could follow the codec periodicity of {20, 40, 60, . . . } ms, and SP offset which represents the time from a target beacon transmit time (TBTT) to the initiation of STA power up where the TWT SP is located, as described in more detail with respect to FIG. 7. A STA may also control the TWT power save mode (PM) in an effort to improve voice quality, as will be described in more detail herein. Given the short size of voice packets, a SP duration of 5 ms is adequate to receive speech samples even at the lower modulation and coding schemes (MCS). The 5 ms SP duration is also an ideal selection to hit the lowest power consumption numbers, when paired with a SP interval of 40 ms or more, as results have shown.

There are several issues, however, with WFC implemented via statically configured TWT session parameters that are addressed herein. For example, a 5 ms TWT slot may not be the right choice as voice packets (e.g., encoded in RTP stream) may have network jitter causing the voice packets to arrive slightly outside the TWT slot. If the STA enters sleep mode exactly at the 5^{th} ms, this will cause an increase of the jitter as seen by the VOIP codec. A 5 ms TWT slot may also not be the right choice even if there is no network jitter but generally higher channel congestion (e.g., industrial, scientific and medical (ISM) band energy, in-basic service set (BSS) Wi-Fi traffic, O-BSS Wi-Fi traffic, or just a poorly designed AP downlink (DL) scheduler) in the AP to STA wireless channel. It is also not distinguishable from a Wi-Fi link perspective if absence of data within a given slot (of any duration) is due to one of the reasons above or just silence from the source.

Codecs have varying packetization intervals and bits per interval and even within a given codec, adaptive multi-rate (AMR) principles are common (e.g., AMR codec operates from 4.75 kbps:94 bits to 12.2 kbps:244 bits per 20 ms frame). Therefore, it may not be ideal to operate with fixed TWT parameters if codec intervals change or codec fidelity changes. For example, stepping down to lower fidelity may mean bad network condition are present and all the more reason to ensure reliable L2/Wi-Fi link. Moreover, it may not always be possible to transmit an UL voice packet in a given 5 ms slot due to various localized and channel interference conditions (such as collocated Bluetooth (BT), collocated long-term evolution (LTE)/license assisted access (LAA)/fifth-generation (5G)-new radio (NR)) or a poorly scheduled UL-orthogonal frequency-division multiple access (OFDMA) scheduler at the AP. It may also not always be conducive to mean opinion score (MOS) (e.g., a measure of voice quality) if the voice packet obtained from codec is stalled until the next TWT service period (which may be 20 ms later).

Certain aspects of the present disclosure are generally directed to techniques for communication of voice packets using a TWT protocol. For example, a STA may monitor voice quality and adjust one or more TWT parameters. As an example, the STA may request that an AP adjust the one or more TWT parameters in response to determining that a voice quality parameter has degraded.

FIG. 5 is a flow diagram illustrating example operations 500 for wireless communication, in accordance with certain aspects of the present disclosure. The operations 500 may be performed by an access point (AP), such as the AP 104.

The operations 500 begin, at block 502, with the AP generating at least one voice packet, and at block 504, outputting the at least one voice packet for transmission to a station, wherein the at least one voice packet is output for transmission during one or more SPs of a TWT protocol. As described in more detail herein, one or more TWT session parameters may be updated based on a quality of a channel used to communicate voice packets. For example, the AP may obtain a frame indicating one or more TWT session parameters are to be updated for a current TWT session, and adjust the one or more TWT session parameters for the current TWT session, the at least one voice packet being output for transmission via the updated one or more TWT session parameters. As another example, the AP may obtain a frame requesting a new TWT session, and initiate the new TWT session, the at least one voice packet being output for transmission during the new TWT session.

FIG. 6 is a flow diagram illustrating example operations 600 for wireless communication, in accordance with certain aspects of the present disclosure. The operations 600 may be performed by a STA, such as the STA 114.

The operations 600 begin, at block 602, with the STA obtaining at least one voice packet from an AP, wherein the at least one voice packet is obtained during one or more SPs of a TWT protocol, and at block 604, by processing the at least one voice packet obtained during the one or more SPs. In certain aspects, the operations 600 may also include adjusting one or more TWT and/or link parameters for obtaining the at least one voice packet based on at least one quality parameter indicative of a quality of a channel used to obtain the voice packet.

For example, based on channel congestion, a TWT slot duration may be adjusted from a minimum time slot (T_{min_slot}) to a maximum time slot (Tmax_{_slot}) interval. In certain aspects, channel congestion may be estimated based on one or more parameters, as described in more detail herein. For example, raw ISM band energy, quantized as a cumulative duration (e.g., represented in a 1 us clock ticks) may be determined. The raw ISM band energy may be detected during a clear channel assessment (CCA) busy time interval, and may be referred to herein as “cca_busy.” Other parameters which may be determined and used for estimating congestion include Wi-Fi traffic seen on the channel (referred to herein as “all_rx”), quantized as a cumulative duration (e.g., represented using the 1 μs clock ticks), directed Wi-Fi traffic to/from the STA (e.g., also referred to herein as “my_rx” and “my_tx”), quantized as a cumulative duration (represented using 1 us clock ticks), and energy (referred to as “silence energy” herein) while the channel is unutilized such as during a silence interval (e.g., during a network allocation vector (NAV) or an interframe space (IFS)). For instance, a congestion estimate (C1), in certain aspects, may be represented by the following equation:

C1= [symbol] (Σ(allₒₜₕₑᵣₛ/Tobs)

where allₒₜₕₑᵣₛ is equal to cca_busy−my_tx−my_rx+silence energy, and Tobs represents an observation window during which the wireless energy is sensed. In certain aspects, a congestion estimate (C2) may be represented by the following equation:

C2= [symbol] (Σ(α*allₒₜₕₑᵣₛ+β*my_rx)/Tobs)

where α and βrepresent weights (e.g., between 0 and 1) to emphasize the allₒₜₕₑᵣₛ or my_rx parameters. The function “ [symbol] ” may be any moving average filter. In certain aspects, the function “ [symbol] ” may be a 1-tap infinite impulse response (IIR) filter, the coefficient of which may be fixed, in one aspect, or adapted, in another aspect, based on external inputs such as high level operating system (HLOS) inputs or internal inputs based on a feedback loop triggered on quality of the WFC, throughput or end to end measured latency.

In certain aspects, the ambient channel congestion, as well as localized data traffic (e.g., user downloading a file or browsing while in WFC) may be considered to adapt the TWT session parameters. This adaptation allows consistent call quality in presence of large traffic which may be scheduled in the STAs UL transmission and the APs downlink scheduling. The various factors described herein may be used to adjust TWT parameters to improve voice quality during WFC. The TWT parameters that may be adjusted are described in more detail with respect to FIG. 7.

FIG. 7 is a timing diagram 700 illustrating different TWT parameters that may be adjusted, in accordance with certain aspects of the present disclosure. As illustrated, during each TWT session, the STA may enter a hardware (HW) transition phase 750, followed by a wakeup phase 752 during which hardware at the STA that was previously in a doze state begin to power up until the STA enters the fully awake state 754. The STA then begins the transition back to the doze state by first entering a sleep phase 756, and another HW transition phase 758.

Certain TWT session parameters may be adjusted instantaneously (e.g., referred to herein as instantaneous adaptation technique), such as the TWT power management (PM) mode, or TWT SP offset. TWT SP offset, as illustrated in FIG. 7, represents the time from the TBTT to the initiation of STA power up where the next TWT SP is located (e.g., the beginning of the HW transition phase 750 from doze to awake mode), as illustrated.

Other TWT session parameters may be adjusted quasi-statically (e.g., referred to herein as a quasi-static adaptation technique) when one or more of the congestion levels are breached against a pre-set threshold, as described in more detail herein. These parameters may include a TWT slot size (e.g., SP duration (SP_dur)) or TWT period (or SP period or SP interval).

In certain aspects, the adaptation of the instantaneous TWT session parameters allow for a rapid reaction to channel uncertainties to prevent impact to call quality (e.g., MOS), while the recalibration of the quasi-static parameters (e.g., using over-the-air (OTA) frame exchanges) may be used to settle within a sweet spot for long term voice quality. In some cases, the adaptation of the quasi-static TWT session parameters may be the only way to react to the breach of a congestion threshold. In certain aspects, each of the TWT session parameters may be adjusted a la carte from the least to the most invasive manner. For example, TWT SP offset may be adjusted first, followed by the TWT PM mode, followed by the TWT slot size, followed by TWT period, or any other combination of the TWT session parameters.

FIG. 8 is a table 800 illustrating TWT parameter settings based on congestion and background traffic, in accordance with certain aspects of the present disclosure. For example, if there is 0 to 20 percent medium congestion, and 0 to 20 percent background traffic belonging to the STA, a TWT time slot of 5 ms may be used. If there is 0 to 20 percent medium congestion, and 20 to 40 percent background traffic belonging to the STA, a TWT time slot of 10 ms may be used, and so on.

It is to be noted that the medium congestion used in the table 800 could be one of the aforementioned C1 or C2 metrics or, in another embodiment, a new metric derived out of one or more channel representing entities. The value “−1” in the table indicates that the PM mode is disabled under respective congestion and background traffic scenarios (e.g., 40 to 60 percent congestion and 40 to 60% background traffic). With PM mode disabled, the STA may receive packets inside or outside TWT slots (e.g., STA may always be awake). STA may go back to PM mode of TWT if the congestion metrics fall back within certain thresholds. Adapting TWT session parameters around medium congestion and background traffic ensures a local layer 2 based adjustment which is self-contained to the Wi-Fi link and the associated technologies that operate in the ISM band.

In some cases, the aforementioned local adaptation of TWT parameters may be insufficient. For example, it may be unclear if call quality is impacted due to different codec rates and varying implementation of a de-jitter buffer (DJB), as will be described in more detail herein. Moreover, it may be unclear if not receiving a voice packet in a given TWT slot implies absence of data from the source (e.g., within a silence interval) or channel congestion (e.g., AP has the voice packet, but is unable to send the voice packet to the STA) or there is an AP scheduling artifact (e.g., AP has not yet scheduled the voice packet).

Absence of voice packet may not directly correlate to an audio quality issue if the source has not really transmitted a packet, being inside a silence window. For instance, speech samples may be played out from the DJB, and thus, draining out of the buffer or possibly triggering an underflow of the DJB. If the TWT session parameter is adapted to widen the TWT slot window (e.g., based on local congestion sensing) assuming a possible call impact, the STA may forgo possible power savings.

Certain aspects of the present disclosure are directed to ascertaining if an L2 link (e.g., Wi-Fi link) is contributing to increased jitter/latency of speech packets, and adapting various L2 link parameters such as TWT session or link reliability, as described in more detail herein. Certain aspects may consider how long voice packets from a source device waited at an AP due to either L2 link congestion or scheduling delays before adapting TWT session parameters. For example, the wait may be explicitly indicated by the AP to the STA, or may be inferred by cross-referencing L4 RTP timestamps to L2 time synchronization function (TSF) timestamps, as described in more detail herein.

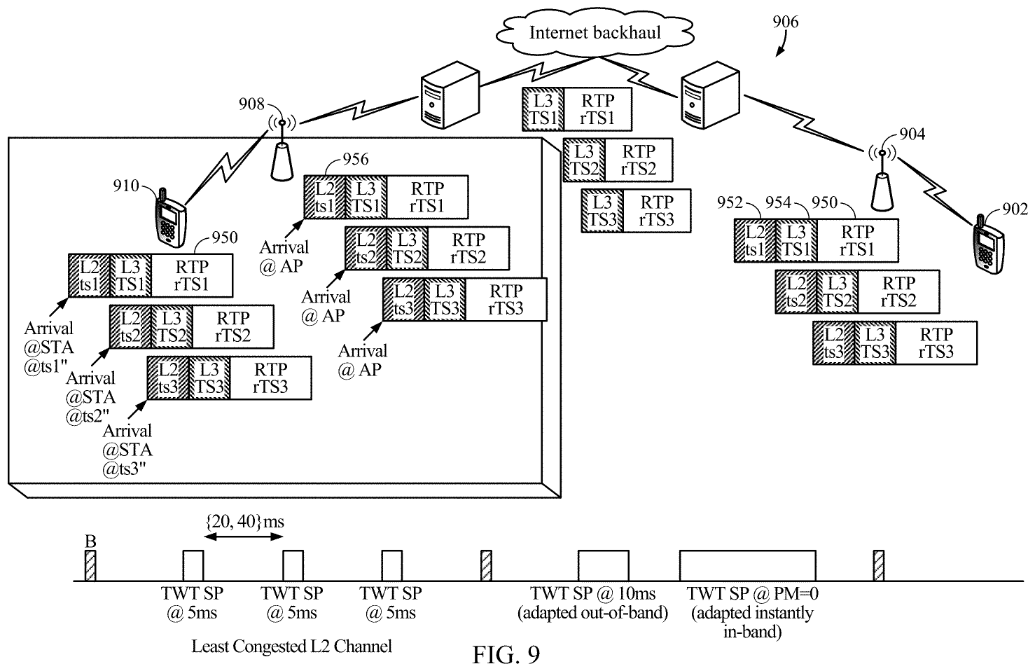

FIG. 9 illustrates a voice packet flow over a RTP link (L4 link) and Wi-Fi link (L2 link), in accordance with certain aspects of the present disclosure. Speech is codified using one of various suitable codecs (e.g., G.711 64 Kbps VOIP codec). A native or compressed RTP (L4) header is appended to a voice packet, as well as a Transmission Control Protocol (TCP)/IP (L3) header, and a Wi-Fi (L2) header. Each of the L2, L3, and L4 headers carry a standard-based timestamp. As illustrated, the L4 (RTP) time stamp (rTS[n]) (e.g., time stamp 950) remains with the voice packet from the source STA 902 as the voice packet is transmitted to source AP 904, and through the backhaul network 906, to the destination AP 908, until received by the destination STA 910. The L2 (Wi-Fi) time stamp (ts[n]) (e.g., time stamp 952) may be removed from the voice packet at the source AP 904. The L3 (TCP/IP) time stamp (e.g., time stamp 954) may be preserved from the source STA 902 to the destination STA 910 depending on various TCP/IP hops and rules.

Certain aspects of the present disclosure use the various time stamps described with respect to FIG. 9 to adapt TWT session parameters. In some cases, delays and/or jitter of voice packets received by a destination RTP stack may be attributable to specific Wi-Fi (e.g., L2 link) artifacts such as aggressive power save policies of the STA, unplanned off-channel excursions (e.g., aggressive roam scans, HLOS scans, location scans), un-prioritized antenna/medium loans to co-channel tech (LAA, LTE, 5G NR or BT), sub-optimal scheduling at the AP, and congestion of the ISM band channel (e.g., in-BSS traffic and o-BSS collisions). Certain aspects of the present disclosure are directed to eliminating (or at least reducing) L2/Wi-Fi contribution to degradation of call quality due to these artifacts. For example, certain aspects involve detecting an increase in latency or jitter natively or with AP assistance, mapping the latency or jitter to one of the artifacts if possible, and adapting various aspects of Wi-Fi instantly for rapid recovery to avoid a dropped call, and then quasi-statically.

Certain aspects of the present disclosure involve explicit L2 time stamp (TSF) signaling by an AP (e.g., destination AP 908). For example, AP 908 may indicate the L2 common TSF (ts[n]) (e.g., time stamp 956) at the ingress of a voice packet destined to the STA 910. The time stamp may be added as a cookie in the egress voice packet in a vendor proprietary signaling format. The STA 910 receives the packet at a different TSF time (ts' [n]), and based on the time stamps ts[n] and ts' [n], may calculate an L2 wait (L2wait) parameter to be used for adapting the TWT session. For example, the L2 wait parameter may be calculated using the equation:

$$L 2 w a i t = \sum \frac{( t s [ n ] - {ts}^{′} [ n ] )}{N}$$

where N represents the number of speech packet samples within any configurable window. Secondary metrics such as the jitter of the L2wait parameter and standard deviation (StdDev) of L2wait parameter may be computed to observe rate of change and spread.

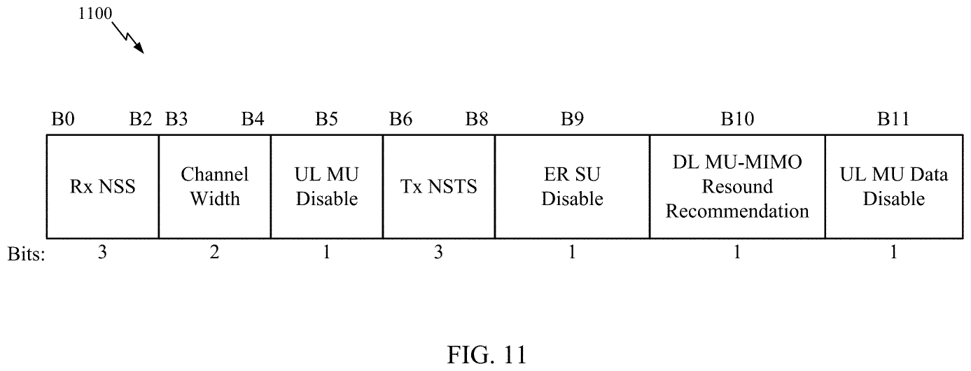

In certain aspects, if the L2wait parameter is greater than a first threshold, the STA may adjust one of the instantaneous parameters (e.g., set TWT/PM-1 to PM-0 in-band using quality of service (QoS) data frame or alter link parameters via IEEE 802.11AX operating mode indication (OMI) and high-efficiency (HE) link adaptation (HLA)) until the L2wait parameter is less than a second threshold. OMI is a procedure available via the IEEE 802.11 AX standard, allowing a STA to change its operating mode settings using the OMI procedure. For example, FIG. 11 illustrates a control subfield 1100 for operating mode control, which indicates one or more link parameters (e.g., receiver number of spatial streams (NSS), channel width) that may be adjusted. Similarly, HLA is a procedure used to adapt link parameters in accordance with the IEEE 802.11 AX standard. In certain aspects, if the jitter of the L2wait parameter is greater than a third threshold or the StdDev of the L2wait parameter is greater than a fourth threshold, the STA may adjust quasi-static parameters (e.g., TWT slot/period adjustment). In certain aspects, one or more link parameters used to obtain voice packets may also be adjusted, such as a bandwidth (BW), number of spatial streams (NSS) or whether aggregation of voice packets is enabled, as described in more detail herein. In certain aspects, the quasi-static parameters may be adjusted until the jitter is less than a fifth threshold and the StdDev is less than a sixth threshold.

Certain aspects of the present disclosure involve computation of a distance metric between L4 and L2 time-stamps with a goal to come up with an upper bound to the maximum delay a source generated voice packet may endure in its travel across the network hops and finally over the L2/Wi-Fi link to the destination STA. For example, the L2 link delay may be estimated indirectly at the STA from a configurable short training window (W ms) when the L2 link is not adapted for power (e.g., forced PM=0 TWT) or any off-channel operations (i.e. no scans or prioritized traffic over BT). A joint estimate is then derived at the STA that tracks the distance (Dw) (time) between the L4 timestamp (rTS[n]) and the L2 timestamp (ts[n]). Over the training window of W ms, the distance metric Dw provides the minimum, maximum, and average encompassing the backhaul latencies, any AP scheduling latency, and any channel congestion latency. The Dw metric serves as a reference for comparing distance calculations of voice packets, as described in more detail herein.

In certain aspects, the Dw metric may be recomputed to maintain a healthy sense of backhaul, AP, channel or codec induced delays. For example, the metric Dw may be recomputed every W ms to adapt around network latency variations. In certain aspects, the metric is re-computed sooner than W ms to account for more rapid alteration of overall latency due to Wi-Fi L2 artifacts. For example, the metric Dw may be re-computed if a detected congestion changes beyond a certain range, which may be representative of large amount of in-BSS traffic or o-BSS traffic or both. The metric Dw may be re-computed based on an explicit indication or implicit derivation of increased BSS load (or increased number of connected STAs) on the AP.

The metric Dw may also be re-computed based on a detected change in receive signal strength indication (RSSI) or signal-to-noise ratio (SNR) beyond a certain range. In some cases, the metric Dw may be re-computed based on an announcement of channel switch by the AP. In certain aspects, Dw may be re-computed when any of the codec metrics indicate a fallout (e.g., underflow of DJB, change of codec rates), signifying an alteration of conditions in backhaul/source codec, although not necessarily of Wi-Fi L2 link. In some cases, Dw may be re-computed when L3 failures associated with the traffic stream crosses a certain threshold. Re-computing the Dw metric facilitates having an accurate upper bound to the overall latency assuming the latency change is contributed to by artifacts caused in L2 (Wi-Fi) artifact, L3 (IP) or L4 (RTP) or any combination of artifacts.

In certain aspects, the STA configures the L2 link to a training mode (PM=0, TWT), and computes (and re-computes as described herein) Dw per the following equation:

$${D}_{w} = \sum \frac{abs ( t s [ n ] - r T S [ n ] )}{N}$$

where N represents the speech packet samples within a W ms window. The STA then configures the L2 link to normal mode (PM=1, TWT), and for every voice packet “i” received, estimates a per packet distance Di per the following equation:

Dᵢ=abs(t[i]−rTS[i])

where t[i] corresponds to the time at which the packet is obtained by the STA (e.g., STA 910), and rTS[i] corresponds to the time at which the packet is encoded by a source STA (e.g., STA 902). The STA also estimates secondary metrics such as Jitter (Dᵢ) and StdDev (Dᵢ). If Dᵢ is greater than D_{w}, the STA may apply instantaneous recovery (e.g., disables PM mode, or reduces SP offset or reconfigures link parameters) until Dᵢ is less than D_{w}. If Jitter (Dᵢ) is greater than a first threshold, or StdDev (Dᵢ) is greater than a second threshold, the STA applies quasi static recoveries (e.g., adjusts the TWT slot/period, or adjusts parameters such as BW, NSS, and/or aggregation configurations) until Jitter (Dᵢ) is less than a third threshold and StdDev (Dᵢ) is less than a fourth threshold.

When a STA configures power save policies with TWT/PM being enabled with a certain slot size (e.g., 5 ms) and with space slots being 40 ms apart, any miss of a packet in slot i, i+1, . . . , (i+j) may cause the Dᵢ to be much larger than the upper-bound Dw. Just because the packet in slot i (in the TWT scheme) is missed, does not mean that the STA will receive the packet on slot i+1. In a congested and/or overly loaded network, the STA may continue to miss the packet in successive slots with an aggressively chosen slot size. When the STA does receive the packet, the STA may observe a Dᵢ much larger than the upper bound Dw. This scheme effectively handles the silence suppression stage as well. In other words, the source encoded RTP timestamp of a packet that ensues after a silence may be an advanced timestamp and may not impact the estimated D_{w}.

A DJB is used in audio codecs to account for network jitter. Certain aspects of the present disclosure are directed to ascertaining DJB behavior (e.g., underflow trigger, rapid change of length) to adjust TWT and link parameters. For example, a depleted (or about to be depleted) DJB may be a sign of a starving decoder and call to feed the decoder voice packets.

The length of the DJB is a measure of insurance that the codec is building for packet delays in the network. Having too lengthy a DJB may cause perceptible delay and lag, even though jitter may be low. Too shallow a DJB may provide little insurance if the network conditions get adverse rapidly causing perceptible jitter (and dropped packets).

In certain aspects of the present disclosure, the STA may determine a rate of length change (RL) of the DJB. RL generally refers to rate at which the length (e.g., available length for correcting voice packet jitter) of the buffer is reduced. In certain aspects, the STA may also determine an absolute buffer length (L) of the DJB buffer. If RL is greater than a first threshold, the STA applies instantaneous L2 link adaptation techniques, as described herein, until RL is less than a second threshold. If L is less than a low water mark (LWM) threshold, the STA applies quasi-static L2 link adaptation techniques, as described herein, including scan suppression, until L is greater than a high water mark (HWM) threshold.

DJB statistic breaches are an artifact of network latencies, channel congestion and AP scheduler delays. But signal fidelity (e.g., represented by RSSI/SNR/error vector magnitude (EVM)) may also contribute to increased jitter as packets may be lost, retried and dropped in L2 link, causing holes in the DJB, which may get played out at some point with a hole in speech sample (e.g., an audio blip).

Certain aspects of the present disclosure are generally directed to ascertaining whether the codecs are changing rate signaling, lowering or upping of the call quality, or if codecs are in a silence window, and adjusting TWT and link parameters accordingly. Adaptive multi-rate codecs balance between source and channel coding in presence of adverse link conditions. Certain aspects of the present disclosure are directed to adjusting L2 link reliability (e.g., via NSS, MCS, BW parameters) in both UL and DL in event of a changes to the codec bit rate or any other codec state changes.

IEEE 802.11AX operating mode indication (OMI) and high-efficiency (HE) link adaptation (HLA) control sent within an UL data packet allows for enforcing link parameters of ensuing DL packets in-band with a transmitted data packet. For example, the NSS may be adjusted. Lowering NSS configures transmit and receive diversity, thereby helping mitigate certain fading conditions and adding higher link margin, at the cost of a longer over the air packet. Adjusting channel BW may improve power spectral density (PSD) of the downlink packets and improves SNR, at the cost of longer packets. Moreover, the STA may provide a recommendation to the AP to limit MCS to a certain range to improve SNR margin, again at the cost of longer packet time. In some cases, the same voice packet (e.g., encoded as an L2 medium access control (MAC) protocol data unit (MPDU)) may be transmitted using a repeated pattern in an aggregated-MPDU (A-MPDU) to improve reliability. Keeping in mind that the voice packets are small, an increase in length due to addition of diversity techniques or lowering of bandwidth, or adoption of a repetition coding, may not necessarily impact the performance much as the increase in channel residency for that packet increases very slightly.

As described herein, VOIP codecs adapt a source bit rate from as low as 4.71 Kbps up to 64 Kbps, which directly translates into MOS variations. VOIP calls adjust the bit rate of a given codec scheme (e.g., while keeping the same payload interval) or apply a new codec scheme (e.g., different bit rate and/or different payload scheme) to adapt around network conditions. In certain aspects of the present disclosure, a STA determines codec state change information as an abstract indication (e.g., categorized from 0-bad to 9-great), and adjusts link parameters accordingly. A pre-characterized look up table may be configured where each encoded codec state (from 0 to 9) are mapped to 3-tuple of link parameter, as illustrated in FIG. 8.

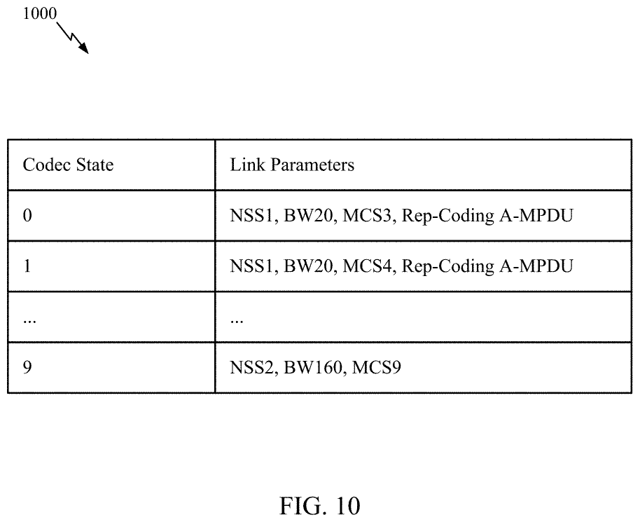

FIG. 10 is a table 1000 illustrating link parameter settings based on codec states, in accordance with certain aspects of the present disclosure. As illustrated, for each of the codec states 0 to 9, different link parameters such as NSS, BW, MCS limit, and whether repetition coding is enabled, are set. In certain aspects, the DJB statistics and the Dw distance metrics, as described herein, may also be considered to adapt around the link parameter sets. In some cases, Dw may be recomputed when a codec state change is detected.

In certain aspects, TWT and link parameters may be adjusted in response to receiving a silence frame. Reception of a silence frame indicates to the STA that the user has stopped talking. In certain aspects, the STA determines the time when the codec receives the first silence frame as an implicit indicator of a lowered bit-rate and larger time between voice packet updates (e.g., silence suppression or comfort noise frames). As the source may interrupt the silence region anytime with a legitimate voice packet, the TWT session parameter (e.g., TWT period) may not be altered unconditionally based on a silence frame indication. For example, silence frame reception may be used as an indicator to immediately return to PM enabled mode of TWT if the previous state configured by the STA was PM disabled mode, while still maintaining the same set of session parameter (e.g., SP offset, slot size, slot period), allowing for a safe transition with little to no impact to MOS as the silence frame trigger is an explicit indication of no immediate voice packets. Alternatively, identifying that the silence window is persisting for a longer time than a certain threshold may motivate an adjustment of the TWT session parameter itself to go from a shallower TWT interval to a deeper interval.

In certain aspects, if silence frames are received for a configurable number of samples, the STA may begin to modify one of the TWT session parameter (e.g., such as TWT periodicity) in an exponential or additive manner. The STA may not alter the slot size that was arrived at based on Dw analysis in aforementioned clauses. This technique provides a telescoping of the TWT periodicity contingent on feedback from the codec of ongoing silence region.

Certain aspects of the present disclosure provide techniques for adjusting TWT parameters for WFC. For example, a STA may send a TWT action frame on an existing TWT session, without terminating a current TWT session. The TWT action frame may indicate a flow identifier (ID) (e.g., a TWT session identifier) set to the flow ID of the current TWT session. Based on the flow ID, the AP determines that the action frame is intended as a parameter renegotiation request rather than a new session request.

The STA may also indicate the new requested parameter values in the action frame, such as a TWT offset (e.g., indicated by a TWT field in the frame), SP duration (e.g., indicated by a wake interval mantissa and wake interval exponent field), and SP interval (e.g., indicated by a nominal minimum wake duration field). A request command field of the action frame may indicate “Suggest TWT” (e.g., indicating that the set of parameters' values included in the request are those that the requesting station is willing to use, but will consider accepting an alternative set), “Demand TWT” (e.g., indicating that the requesting station wants to set an agreement but will not accept a set of parameters different than the one in the request message), or “Request TWT” (e.g., indicating that the requesting station is willing to set a TWT agreement and lets the responding station or AP specify the TWT parameters), or any other value valid for a TWT request frame.

If the AP accepts the new parameters from the STA, the AP may send a TWT response frame with a command field set to “Accept TWT” and updated parameters set to the new values. If the AP rejects partial or all of the parameters, the AP may send a TWT response frame with the command field set to “Accept TWT” and indicate the accepted parameters set to the new values and the unaccepted parameters set to current values. In certain aspects, the AP may also send a TWT response frame with command field set to “Reject TWT” or any command valid for AP, and indicate all the parameters set to current values.

In certain aspects, the STA may send a TWT teardown frame to terminate the current TWT session first, and then send a TWT setup frame to request a new session. New TWT parameter values may be indicated in the request frame, as described herein, for the new TWT session.

Certain aspects of the present disclosure provide techniques for improving communication efficiency by conveying information between codec and WiFi systems. For example, in certain aspects, power efficiency of codec and IMS may be improved by coordinating codec and IMS operations with the WiFi system, as described in more detail herein with respect to FIG. 12. IMS is an architecture framework for delivering IP multimedia services.

FIG. 12 illustrates example operations 1200 for improving power efficiency, in accordance with certain aspects of the present disclosure. As illustrated, codec/IMS hardware (e.g., codec component 128) may enter a low-power mode of operation in sync with when the WiFi system (e.g., TWT component 126) is in low-power mode (doze state) between the TWT SPs 1202, 1204. For example, the codec component 128 may receive information from the TWT component 126 regarding the timing of TWT SPs, and may configure a low-power mode of the codec hardware accordingly. The codec may begin a hardware transition phase to exit the low-power state to an active state at a configurable time period (e.g., a few milliseconds) before the beginning of the TWT SP 1204 for codec frame generation. For example, the codec hardware may generate audio frames, which may be transferred to an RTP stack of the STA 114 for encoding such that the frames may be transmitted to the network via WLAN during the SP 1204. In other words, power consumption by the codec may be reduced by synchronizing the frame generation of the codec component 128 with the TWT SPs during which the WiFi system is active.

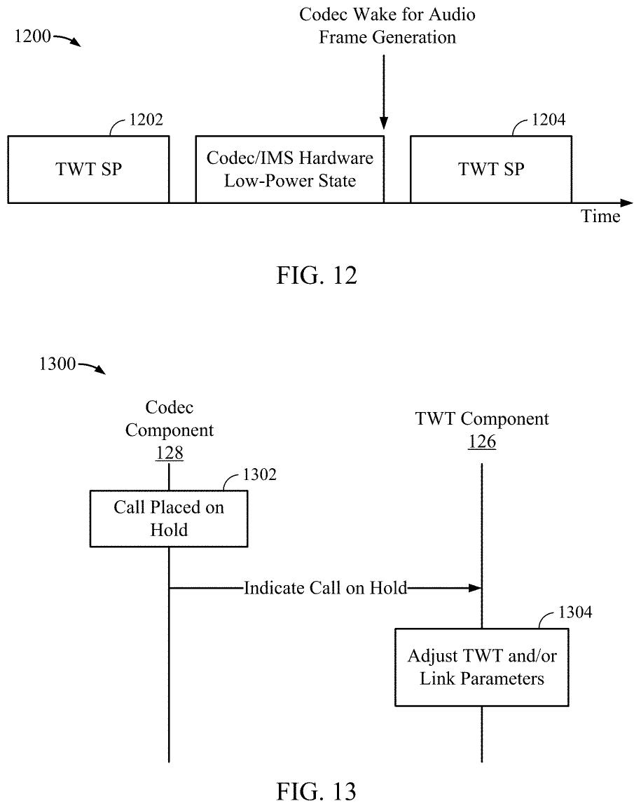

FIG. 13 illustrates example operations 1300 for setting WiFi communication parameters based on whether a corresponding call has been placed on hold, in accordance with certain aspects of the present disclosure. If a user places a VOIP call on hold, frame generation scheme of the codec component 128 may be reconfigured with longer voice packet transmission intervals. In certain aspects, at block 1302, the codec component 128 may determine that a call has been placed on hold, and subsequently, indicate to the WiFi system (e.g., TWT component 126) that the VOIP call is on hold, as illustrated. The TWT component 128 may then, at block 1304, adjust the WiFi configuration accordingly (e.g., adjust TWT and/or link parameters). For example, the TWT component 126 may trigger a low-power mode of operation (e.g., enable PM mode), and/or increase the TWT period based on the indication that the VOIP call is on hold.

In certain aspects, when the VOIP call is on hold, the TWT session may be paused entirely by the TWT component 126. In other words, instead of the WiFi system waking up to receive each beacon (e.g., beacon 402 as described with respect to FIG. 4), as well as during each TWT SP, the TWT session may be placed on hold such that the WiFi system only wakes up to receive beacons, and no longer wakes up during each of the TWT SPs, further improving power efficiency. Once a new voice packet is received, indicating that the VOIP call is no longer on hold, the TWT session may be resumed using the TWT parameters last configured.

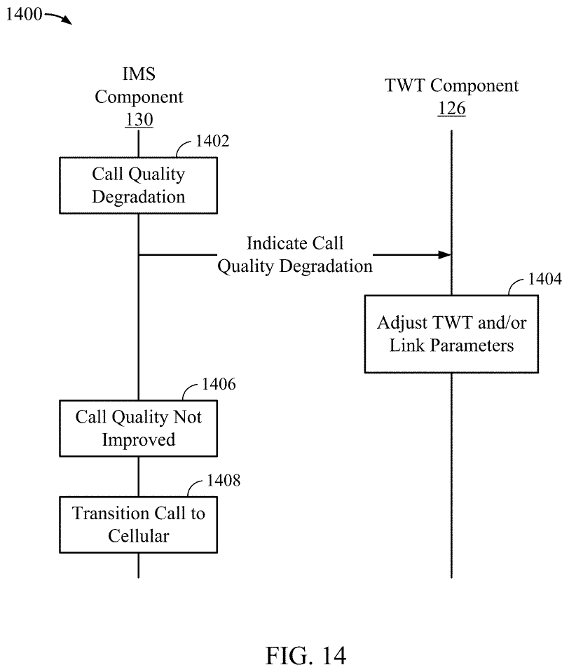

FIG. 14 illustrates example operations 1400 for improving link quality prior to transition of a voice call to cellular, in accordance with certain aspects of the present disclosure. Currently, an IMS component 130 monitors call metrics such as end-to-end delay and jitter buffer status to determine whether call quality has been compromised. If so, the IMS transitions the voice call from WiFi to cellular to improve user experience.

Certain aspects of the present disclosure implement a delay prior to the transition to cellular to allow the TWT component 126 to improve the call quality by adjusting TWT and/or link parameters. For example, the IMS component 130 may, at block 1402, determine that call quality has degraded based on call quality metrics, and indicate to the TWT component 126 that the call quality has been degraded. At block 1404, the TWT component 126 may adjust TWT and/or link parameters to improve call quality based on the indication from the IMS component 130. For instance, the TWT component 126 may employ the instantaneous adaptation technique described herein to improve the call quality in an effort to avoid the call transition to cellular. The IMS component 130 may wait for a configurable time period before reassessing, at block 1406, the call quality to determine whether the call quality has improved, and if not, may then transition to cellular at block 1408.

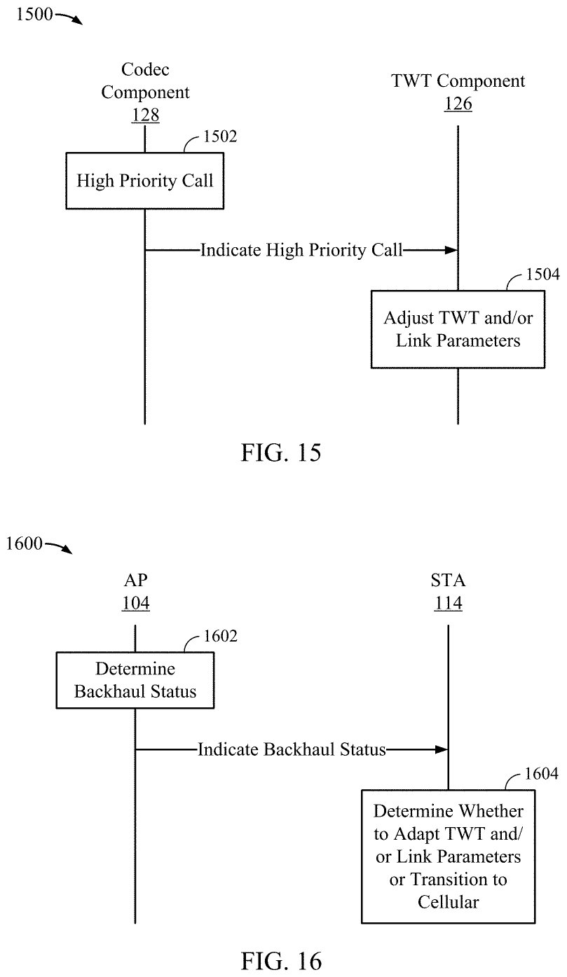

FIG. 15 illustrates example operation 1500 for adjusting TWT and/or link parameters based on call priority, in accordance with certain aspects of the present disclosure. An emergency call may first be placed on a cellular network. If the cellular call is unsuccessful, WiFi may be used for the emergency call instead. In other words, using WiFi for an emergency call may be the last resort for communicating an emergency, and it is therefore very important to improve the reliability of the voice call. Therefore, as described with respect to FIG. 15, the codec component 128 may indicate to the TWT component 126 that a voice call is a high priority call (e.g., emergency call or real-time text (RTT) call), based on which the TWT component 126 may make adjustments to improve the call reliability.

For example, at block 1502, the codec component 128 may determine that a call is high priority and indicate the high priority call to the codec component. At block 1504, the codec component may adjust TWT and/or link parameters to improve call reliability. For instance, the TWT parameters and/or link parameters may be set to improve call quality if a voice call is an emergency call or RTT call. An RTT call allows for texting in real time to communicate during a phone call.

In certain aspects, the WiFi system may adjust layer 1 and layer 2 (physical and data layers) aspects of WiFi, and the TWT component 126 may disable PM mode to improve the reliability of the high priority call. In some cases, the TWT component 126 may stay in TWT mode, but lower the TWT period and/or extend the SP slot durations to improve call quality. In some cases, receiver operating mode indication (ROMI) and transmitter operating mode indication (TOMI) parameters may be adjusted to focus on reliability. Operating mode indication (OMI) is described in more detail herein with respect to FIG. 11.

FIG. 16 illustrates example operation 1600 for configuring a voice call based on backhaul link estimation, in accordance with certain aspects of the present disclosure. For example, the AP 104 may, at block 1602, determine the status of the backhaul, and indicate the backhaul status to the STA 114 (e.g., via a proprietary message). For instance, the AP 104 may indicate a backhaul link performance parameter to the STA 114. The backhaul link performance parameter may be an indication of whether there are packets awaiting communication to the STA 114 which cannot be communicated due to problems with the backhaul, such as congestion of the medium or scheduling issues, based on which the STA 114 may, at block 1604, determine whether to adapt TWT and/or link parameters, or transition the call to cellular if the backhaul link performance parameter is less than a threshold.

For example, the AP may indicate the estimated throughput of the backhaul, such that the codec component 128 may determine whether end to end call latency is caused by the WiFi link or by issues associated with the backhaul link of the AP. Based on this information, the codec component 126 may determine whether to transition the voice call from WiFi to cellular. For example, if the call quality has degraded, the codec component 128 may transition the call to cellular without delaying for the TWT component 126 to adjust TWT and/or link parameters, since such adjustments would not improve call quality issues that are caused by the backhaul link of the AP.

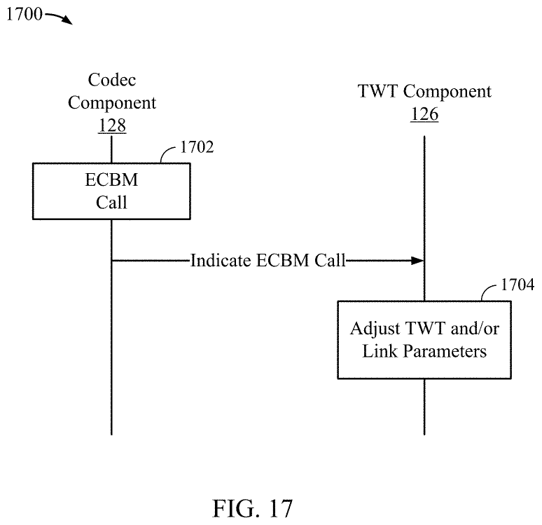

FIG. 17 illustrates example operations 1700 for facilitating an emergency call back mode (ECBM), in accordance with certain aspects of the present disclosure. ECBM is a protocol that allows an operator to quickly make a call back to a previous caller after the caller has made an emergency 911 call. In certain aspects, at block 1702, the codec component 128 may determine that a call is for the ECBM, and conveys this information to the TWT component 126, as illustrated. At block 1704, the TWT component 126 may configure TWT and/or link parameters to improve call reliability based on the indication from the codec component 128. For example, the TWT component may disable PM mode for the TWT session to improve reliability for receiving the call back associated with the ECBM. The WiFi system may also use TOMI, ROMI, and HLA, as described herein, to improve link reliability for the call back.

Although certain aspects have been described in relation to the 802.11AX standard, it is to be understood that the disclosed aspects may also apply to other 802.11 standards, such as 802.11ah, 802.11ac (or any other IEEE standard such as 802.11 standards a, b, g, n, ad, ah, az, ba, be, etc.) and Extreme High Throughput (EHT), and to cellular standards as well.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Means for receiving or means for obtaining may include a receiver (such as the receiver 312) or an antenna(s) (such as the antenna 316). Means for transmitting, means for sending or means for outputting may include a transmitter (such as the transmitter 310) or an antenna(s) (such as the antenna 316). Means for processing, means for adjusting, means for determining, means for detecting, means for disabling, means for reducing, means for increasing, means for handing over, means for pausing, means for generating, means for encoding, means for transitioning, means for entering, means for terminating, and means for initiating may include a processing system, which may include one or more processors, such as the processor 304.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a station 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. In certain aspects, the computer program product may include packaging material.

Further, it should be appreciated that modules and/or other appropriate means for performing the methods and techniques described herein can be downloaded and/or otherwise obtained by a station and/or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a station and/or access point can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
an interface configured to obtain at least one voice packet from an access point (AP), wherein the at least one voice packet is obtained during one or more service periods (SPs) of a target wake time (TWT) protocol; and
a processing system configured to process the at least one voice packet obtained during the one or more SPs.

2. The apparatus of claim 1, wherein the processing system is configured to adjust one or more TWT parameters for obtaining the at least one voice packet based on at least one quality parameter indicative of a quality of a channel used to obtain the at least one voice packet.

3. (canceled)

4. The apparatus of claim 2, wherein the at least one quality parameter comprises a medium congestion parameter determined based on raw band energy.

5. The apparatus of claim 4, wherein the apparatus is associated with a STA, wherein the at least one quality parameter comprises another parameter determined based on the medium congestion parameter representing raw band energy, wireless energy corresponding to Wi-Fi traffic to and from the STA, and silence energy corresponding to a period of a channel for obtaining the at least one voice packet that is un-utilizable for Wi-Fi activities even though there is no energy during the period.

6-7. (canceled)

8. The apparatus of claim 5, wherein at least one quality parameter corresponds to an average of the other parameter for each of a plurality of samples taken during a sampling window.

9. The apparatus of claim 8, wherein the processing system is configured to adjust, based on the at least one quality parameter, one or more filter weights for the averaging of the other parameter for each of the plurality of samples.

10. (canceled)

11. The apparatus of claim 5, wherein the at least one quality parameter corresponds to a moving average filter of the other parameter across a plurality of samples taken during a sampling window.

12. The apparatus of claim 11, wherein the moving average filter comprises a single-tap infinite impulse response (IIR) filter of the other parameter across each of a plurality of samples taken during a sampling window.

13. (canceled)

14. The apparatus of claim 2, wherein the apparatus is associated with a STA, and wherein the at least one quality parameter corresponds to a measure of ambient channel congestion as well as an amount of data traffic pertaining to the STA.

15. (canceled)

16. The apparatus of claim 2, wherein the apparatus is associated with a STA, and wherein the processing system is configured to determine the at least one quality parameter based on at least one first time stamp corresponding to a time at which at least one other voice packet is obtained by the STA.

17. The apparatus of claim 16, wherein the processing system is further configured to determine the at least one quality parameter based on at least one second time stamp corresponding to a time at which the at least one other voice packet is received by the AP.

18. (canceled)

19. The apparatus of claim 17, wherein the at least one quality parameter comprises a wait time parameter determined based on an average of a difference between the first and second time stamps across a plurality of voice packet samples.

20. (canceled)

21. The apparatus of claim 19, wherein:
if the wait time parameter exceeds a first threshold, the processing system is configured to adjust at least one of a TWT PM mode or a TWT SP offset of the TWT protocol; and
if a standard deviation or a jitter of the wait time parameter exceeds a second threshold, the processing system is configured to adjust at least one of a TWT slot size or TWT period of the TWT protocol.

22. The apparatus of claim 16, wherein the processing system is further configured to determine the at least one quality parameter based on a second time stamp corresponding to a time at which the at least one voice other packet is encoded by another STA, the other STA being a source of the at least one voice packet.

23-27. (canceled)

28. The apparatus of claim 2, wherein the at least one quality parameter comprises at least one of:
a rate of length change parameter indicating a rate of length change of a de jitter buffer (DJB); or
an absolute buffer length available at the DJB for correcting voice packet jitter.

29. The apparatus of claim 28, wherein:
if the rate of length change parameter exceeds a first threshold, the processing system is configured to adjust at least one of a TWT PM mode or a TWT SP offset of the TWT protocol; and
if the absolute buffer length is less than a second threshold, the processing system is configured to adjust at least one of a TWT slot size or a TWT period of the TWT protocol.

30. (canceled)

31. The apparatus of claim 1, wherein the processing system is further configured to:
detect that the at least one voice packet is associated with a high priority call; and
adjust one or more TWT or link parameters for obtaining the at least one voice packet for improved reliability based on the detection.

32-34. (canceled)

35. The apparatus of claim 1, wherein the processing system is configured to:
detect that the at least one voice packet is associated with an emergency call back mode (ECBM); and
adjust one or more TWT or link parameters for obtaining the at least one voice packet for improved reliability of receiving a call back associated with the ECBM based on the detection.

36. (canceled)

37. The apparatus of claim 1, wherein:
the at least one voice packet is associated with a call via a voice over internet protocol (VOIP);
the interface is further configured to obtain at least one parameter indicating backhaul link performance; and
the processing system is further configured to handover the call from the VOIP to a cellular protocol based on the backhaul link performance.

38. (canceled)

39. The apparatus of claim 1, wherein:
the at least one voice packet is associated with a call via a VOIP; and
the processing system is configured to:
detect that the call is on hold; and
adjust one or more TWT parameters for obtaining the at least one voice packet based on the detection that the call is on hold.

40-41. (canceled)

42. The apparatus of claim 1, wherein the at least one voice packet is associated with a call via a VOIP, and wherein the processing system is further configured to:
detect degraded quality of the call based on one or more call quality metrics; and
adjust one or more TWT parameters for obtaining the at least one voice packet based on the detection of degraded quality.

43. The apparatus of claim 42, wherein the processing system is further configured to:
detect whether the one or more call quality metrics have improved above a threshold after the adjustment of the one or more TWT parameters; and
handover the call from the VOIP to cellular if the one or more call quality metrics have not improved above the threshold.

44. The apparatus of claim 1, wherein:
the processing system is configured to:
generate one or more codec frames to be encoded for transmission during the one or more SPs, wherein codec hardware for generating the one or more codec frames are in a low-power state during a time period prior to the one or more SPs; and
encode the one or more codec frames as one or more voice packets for transmission during the one or more SPs of the TWT protocol; and
the apparatus further comprises another interface configured to output the one or more voice packets for transmission during the one or more SPs.

45-46. (canceled)

47. The apparatus of claim 1, wherein the processing system is configured to adjust one or more link parameters for obtaining the at least one voice packet based on a voice over internet protocol (VOIP) codec state used to process the at least one voice packet.

48. The apparatus of claim 47, wherein adjusting the one or more link parameters based on the VOIP codec state comprises detecting a change of a type of VOIP codec used to process the at least one voice packet, and wherein the one or more link parameters is adjusted based on the detection.

49. (canceled)

50. The apparatus of claim 47, wherein the one or more link parameters comprise a number of spatial streams, a channel bandwidth, a modulation and coding scheme (MCS) limit, or whether repetition of voice packets in an aggregated-medium access control (MAC) protocol data unit (A-MPDU) is enabled.

51. The apparatus of claim 1, wherein the interface is configured to obtain one or more silence frames, the processing system being configured to adjust one or more TWT parameters for obtaining the at least one voice packet in response to obtaining the one or more silence frames.

52. (canceled)

53. The apparatus of claim 1, wherein:
the processing system is configured to:
determine that one or more TWT session parameters are to be updated for a current TWT session for obtaining the at least one voice packet; and
generate a frame indicating the one or more TWT session parameters are to be updated; and
the apparatus further comprises a second interface configured to output the frame for transmission during the current TWT session.

54-55. (canceled)

56. The apparatus of claim 1, wherein:
the processing system is configured to:
determine that one or more TWT session parameters for obtaining the at least one voice packet are to be updated;
terminate a current TWT session; and
generate a frame requesting a new TWT session; and
the apparatus further comprises a second interface configured to output the frame for transmission.

57-173. (canceled)

174. A station comprising:
at least one antenna;
an interface configured to obtain, via the at least one antenna, at least one voice packet from an access point (AP), wherein the at least one voice packet is obtained during one or more service periods (SPs) of a target wake time (TWT) protocol; and
a processing system configured to process the at least one voice packet obtained during the one or more SPs.

175-195. (canceled)
